(19) United States
(12) Patent Application Publication
(10) Pub. No.: US 2010/0287814 A1
(43) Pub. Date: Nov. 18, 2010

(54) WEIGHTED HOOKS FOR FISHING

(76) Inventor: Timothy W. Barefoot, Wilmington, NC (US)

Correspondence Address: JENKINS, WILSON, TAYLOR & HUNT, P. A., 3100 Tower Blvd., Suite 1200, DURHAM, NC, 27707, US

(21) Appl. No.: 12/778,788

(22) Filed: May 12, 2010

Related U.S. Application Data
(60) Provisional application No. 61/216,008, filed on May 12, 2009.

(51) Int. Cl. A01K 83/00

(52) U.S. Cl. 43/44.81

(57) ABSTRACT

Weighted hooks are disclosed in which a hook can include a hook body including a shank and a bend. The hook can include a weight disposed on the hook body. The weight can reside on the shank and extend over at least a portion of the bend. The weight can be configured to have its mass distributed on the hook body to balance the hook such that, when trolling with the hook in water, the hook is stabilized in a position with the bend of the hook body being closer to a surface of the water than the shank being to the surface of the water.

### RELATED APPLICATION

The presently disclosed subject matter claims the benefit of U.S. Provisional Patent Application Ser. No. 61/216,008, filed May 12, 2009, the disclosure of which is incorporated herein by reference in its entirety.

### TECHNICAL FIELD

Generally, embodiments of hooks for fishing that are balance weighted are provided. More particularly, hooks and related methods for use in fishing are provided wherein a hook has a weight that can be disposed thereon with the weight configured so that its mass is distributed on the hook body to balance the hook such that when trolling with the hook in a body of water, the hook is stabilized in a predetermined and desired position relative to a surface of the body of water.

### BACKGROUND

Circle hooks are increasingly used in today's fishing industry and in recreational fishing. Demand has steadily grown from a base in marine commercial fisheries, particularly longlining, where baited hooks are set to fish passively. In addition to setting without rod action, circle hooks are favored in commercial fisheries because they hook and retain fish, even on slack lines. They also tend to hook fish in the jaw, causing less mortality than standard J-hooks.

Recreationally, inland, trotliners and limbliners first tried circle hooks. Today, more anglers are experimenting with circle hooks for various species, based on their perceived benefits. These benefits include for example: jaw hooking, which should make removal easier; reduced gut-hooking, resulting in less mortality; and easy setting of the hook, which would be ideal for inexperienced anglers and in deep water situations. Other possible advantages include fewer lost fish, fewer snags, and safer handling. Recently, fishery management agencies have recommended circle hooks for their conservation benefits. In some situations, such as some fishing tournaments even, regulations even require circle hooks.

The term “circle hook” as used herein is defined as a range of hook designs that generally provide a more circular shape than a traditional J-hook, including but not limited to models with a point that mildly turns toward the shank of the hook, hooks having a bend that extends outward from the shank and curves around to extend at least partially towards the shank, and a hook having a bend that includes multiple radii of curvatures and has its point that turns toward the shank.

Recently, there has been a rise in scientific studies of circle hooks and their related tools, particularly their anatomical hooking position, degree of wounding, hooking success rate, and mortality. Most have addressed marine fisheries, with striped bass the most common subject. This is due to the huge striper fishery on the East Coast, where annual catch-and-release angling mortality has been estimated at 1.3 million fish, more than the number taken in the commercial fishery in a normal year. Generally, the species most studied are those commonly captured on live or dead baits and those that have substantial hooking mortality with conventional hooks.

From a management standpoint, hooking mortality is critical when regulations require release of fish of a certain size range. Of course, fish that are voluntarily released should be in viable condition. Delayed mortality can be important, but it is far more challenging to measure. When results of all studies were combined, circle hooks resulted in lower mortality than other types, mostly J-hooks and octopus styles. For example, mortality estimates for circle hooks ranged from 0 to 34 percent, compared to 0 to 46 percent for J-hooks.

There is substantial variation among species, however. For striped bass, mortality with circle hooks appears to range from under 1 percent to 6 percent while J-hooks accounted for 9 to 18 percent mortality, a sizeable difference. Red drum, salmon, and tuna also showed major differences.

In studies though with bluegill and pumpkinseed, rock bass, largemouth bass, and summer flounder, mortality rates appear to be similar between circle hooks and conventional designs (including octopus, sproat, and widegap). Bass mortality has been measured to be low with circle (5.1 percent) and octopus (6.6 percent) hooks with fathead minnows as bait. Sunfish mortality has appeared to be extremely low for all hook types (1 percent) and no measurable amount of rock bass in the reviewed scientific studies have been killed by hooking. For flounder, mortality for all hook types appears to be between 12 and 16 percent.

Physiological damage from hook setting and removal can be minor or severe, including brain damage, blinding, and gill tearing. Reports from post-mortem exams of stripers killed with conventional hooks found damage to the heart, liver, gill arch, kidneys, and intestines. As circle hooks are not often swallowed, such damage is reduced. It has been found that jaw hooking is far more frequent with circle hooks than other types. The incidence of gut hooking with circle hooks is also low (generally less than 5 percent). Bleeding also was lower with circle hooks, a factor often related to hooking location.

Time required to remove hooks can affect mortality, since fish are typically held out of water during the process. It is believed that circle hooks generally can be more difficult to remove. But again, this factor varies among fish species and likely also varies based on specific design and hook size in relation to fish size.

Hooking efficiency is important to anglers and managers, as regulations requiring circle hooks will not be well received if anglers seem to miss or lose more fish than with traditional designs. The overall conclusion from the compilation of the studies is that J-hooks hooked fish more readily than circle hooks, but when hooked, circle hooks were responsible for higher landing rates.

Hooking efficiency is related to equipment and experience. As experienced users have learned, circle hooks do not typically work well with stiff rods and standard hooksets. Slower action rods allow fish to pull against the rod without ejecting the bait, while the hook slides to the jaw and often into the corner of the mouth. Hooksets snatch the hook out, without giving the hook point a chance to catch and eventually set. This behavior must be learned, however, and habits die hard. Moreover, circle hooks do not work well for fish that nibble at baits without engulfing them, since hook-ups require that the hook be fully within the fish's mouth.

Circle hooks can range in size. Though there are general guidelines, it is often impractical to use hooks to match the expected size of fish. Large circle hooks do not hook small fish efficiently, and there is evidence that small circle hooks are more likely to hook larger fish in the gullet. This was evident in a study with sunfish. Larger circle hooks also may cause more eye-hooking of small fish, though they do not hook small fish efficiently.

In describing hooks, “offset” refers to the amount of deviation in the plane of the hook point relative to that of the shank. In studies of sailfish and striped bass, offset circle hooks caused more damage than non-offset ones, but this result has not been consistent. It appears that the degree of offset (15 degrees is considered severe) affects rate of damage and mortality.

Now, several jurisdictions require circle hook use. For example, Canadian white hake fisheries; some Maine groundfish (cod, haddock, etc.); some California coastal salmon fisheries; and a section of the Delaware River striper fishery all require use of circle hooks. Further, bill fishing tournaments and tournaments of large game fish have begun to require the use of circle hooks when using live or dead bait.

A problem arises in using circle hooks or J-hooks when trolling with live or dead bait. It is extremely hard to hook the bait on a circle hook and J-hooks to create swimming action with the bait. When using circle hooks and J-hooks, the bait has a tendency to spin or rotate on the longitudinal axis of the bait, instead of the tail of the bait creating a more natural swimming action of the tail oscillating from side to side for fish or the swimming movement of squid, for example. This is especially true if the bait is improper hooked, which often is the case.

### SUMMARY

It is an object of the presently disclosed subject matter to provide novel hooks that are weighted in a predetermined and desirable manner. In particular, the hooks can be weighted such that, when trolling with the hooks in water, the hooks can be stabilized in a position with the bends of the hook bodies being generally closer to a surface of water than the shanks.

An object of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including the accompanying figures attached hereto, in which:

FIG. 1 illustrates a side view of an embodiment of a weighted hook according to the present subject matter;

FIG. 2 illustrates a top view of the embodiment of the weighted hook according to FIG. 1;

FIG. 3 illustrates a rear view of the embodiment of the weighted hook according to FIG. 1;

FIG. 4A illustrates a side view of another embodiment of a weighted hook according to the present subject matter;

FIG. 4B illustrates a cross-sectional view of the embodiment of the weighted hook shown in FIG. 4A taken along line 4B-4B of FIG. 4A;

FIG. 4C illustrates a cross-sectional view of the embodiment of the weighted hook shown in FIG. 4A taken along line 4C-4C of FIG. 4A;

FIG. 5 illustrates a side view of further embodiment of a weighted hook according to the present subject matter;

FIG. 6A illustrates a side view of another embodiment of a weighted hook according to the present subject matter;

FIG. 6B illustrates a cross-sectional view of the embodiment of the weighted hook shown in FIG. 6A taken along line 6B-6B of FIG. 6A;

FIG. 6C illustrates a cross-sectional view of the embodiment of the weighted hook shown in FIG. 6A taken along line 6C-6C of FIG. 6A;

FIG. 7 illustrates side views of different sized embodiments of weighted hooks according to the present subject matter;

FIG. 8 illustrates a side view of an embodiment of a weighted hook baited with a bait fish according to the present subject matter; and

FIG. 9 illustrates a side view of an embodiment of a weighted hook baited with a bait fish and in use in a body of water according to the present subject matter.

### DETAILED DESCRIPTION

Reference will now be made in detail to possible embodiments of the present subject matter, one or more examples of which are shown in the figures. Each example is provided to explain the subject matter and not as a limitation. In fact, features illustrated or described as part of one embodiment can be used in another embodiment to yield still a further embodiment. It is intended that the subject matter disclosed and envisioned herein covers such modifications and variations.

Hooks used for fishing are provided that can be easily baited and still produce the intended swimming action of the bait when trolling. A hook according to the present subject matter can comprise a hook body having a first end and a second end. The hook can be a circle hook or a J-hook. The hook body can include an eye on a first end of the hook body having an aperture therein and a shank extending linearly from the eye. The hook body can also include a bend curving from the shank. The hook body can have a point on a portion of the bend on the second end of the hook body. The hook can further comprise a weight that can, for example, be disposed on at least a portion of the hook body. The weight can reside on the shank and can extend over at least a portion of the bend. The weight can curve in generally the same direction as the bend of the hook body curves.

In some embodiments, the bend of the hook can include, for example, at least two radii of curvatures, with a first radius of curvature extending from the shank and a second radius of curvature extending between the first radius of curvature and the point. The weight can extend from the shank around the first radius of curvature of the bend of the hook body. The shank and the bend of the hook body can define an inside area of the hook body therein and a majority of the mass of the weight can reside on an outer perimeter outside of the inside area of the hook body. The portion of the weight on the first radius of curvature of the bend can be greater in mass than the portion of the weight on the shank. The point can include a barb that extends into the inside area of the hook body. The point can extend toward the shank. For example, the point can curve toward the shank at a constant radius of curvature in circle hooks.

The weight can be configured to have its mass distributed on the hook body to balance the weight in a desired and predetermined manner. More specifically, the configuration of the weight can be such that, when trolling with the hook in a body of water with the hook attached to bait such as a smaller fish-type bait, the hook can be disposed through at least a portion of the head, chin and/or mouth of the fish bait and the hook remains in an upright position where the hook is stabilized in position with the bend of the hook body being closer to a surface of the body of water than the shank is. This means the point of the hook resides above the shank when trolling. Such an orientation with the point of the hook being in an upper position above the shank can also help to prevent snagging on material within the water like underbrush or weeds by keeping the point of the hook up in the water. The mass and configuration of the weight can stabilize the position of the hook with the bend of the hook body being closer to the surface of the body of water than the shank when the hook is attached to bait. The mass of the weight can also be desirably balanced to create a swimming action in a live or dead bait fish with a tail of the bait fish oscillating from side to side upon trolling at an appropriate speed.

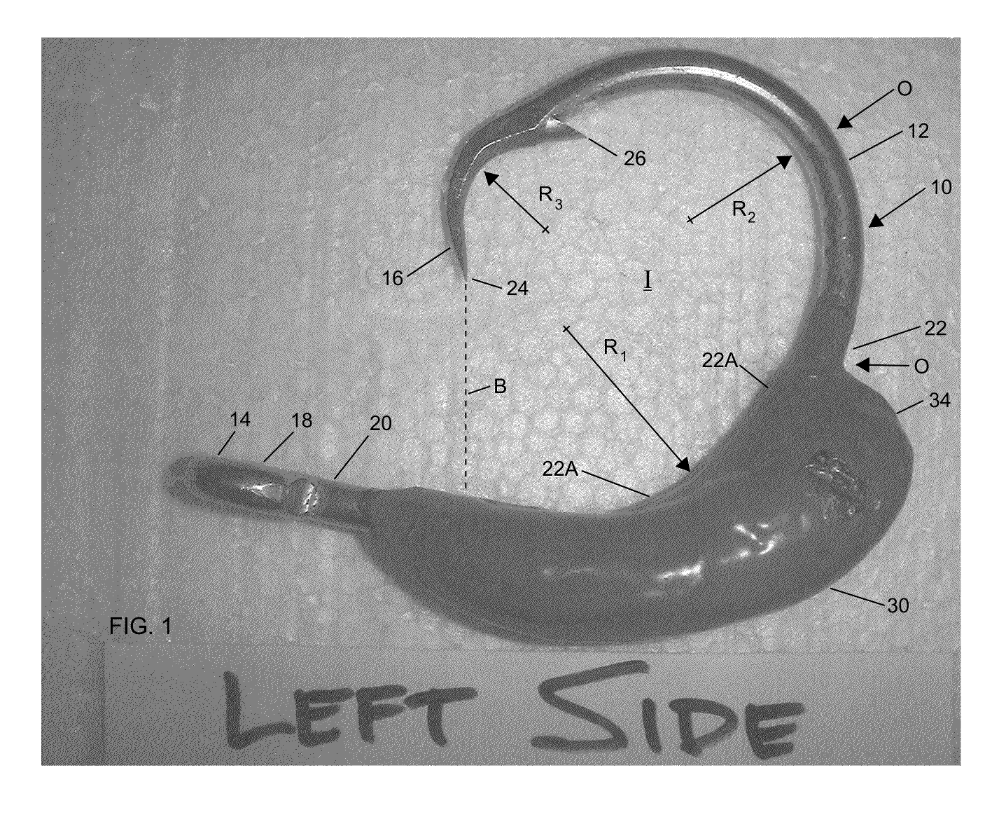

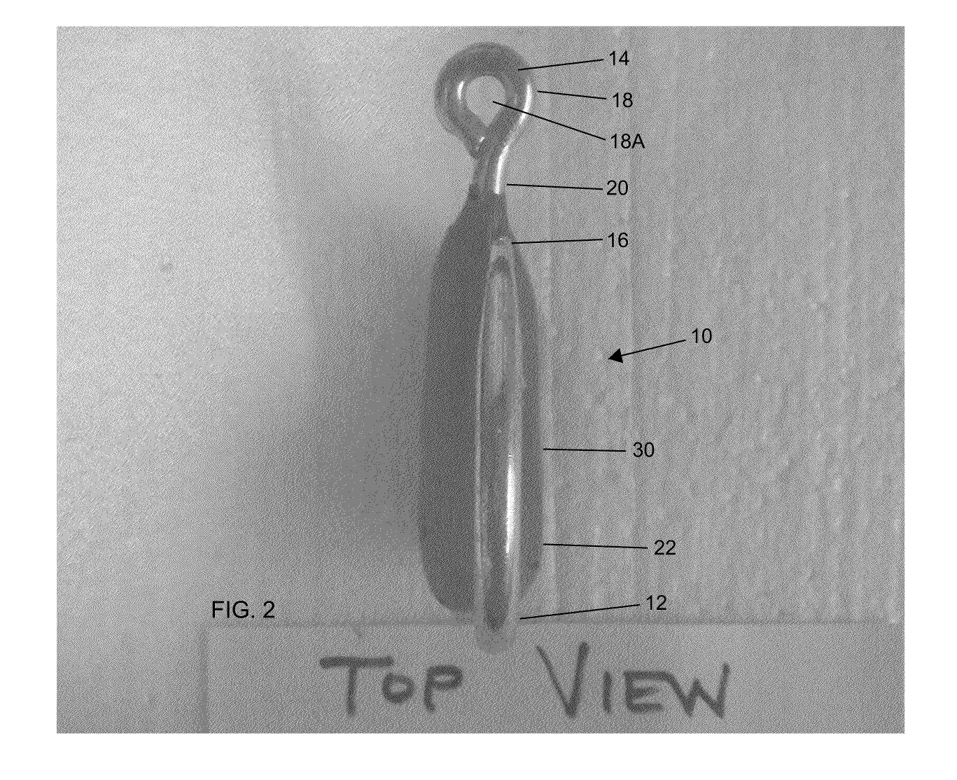

FIGS. 1-4A illustrates a circle hook 10 that can be easily baited and still produce the intended swimming action of the bait when trolling. Hook 10 can comprise a circle hook body 12 having a first end 14 and a second end 16. Circle hook body 12 can also include an eye 18 on first end 14 of circle hook body 12 having an aperture 18A therein (see FIG. 2) and a shank 20 extending linearly from eye 18. Circle hook body 12 can also include a bend 22 curving outward from shank 20 and curving back toward shank 20. Circle hook body 12 can have a point 24 on a portion of bend 22 that curves back toward shank 20 on second end 16 of circle hook body 12. Hook 10 can further include a weight 30 that can, for example, be disposed on at least a portion of circle hook body 12. For example, weight 30 can be integral to hook body 12. Alternatively, weight 30 can be removably attached to hook body 12. Weight 30 can reside on shank 20 and can extend over at least a lower portion 22A of bend 22. Weight 30 can curve in generally the same direction as bend 22 of circle hook body 12 curves. Circle hook 10 can be non-offset and can be tournament legal.

Weight 30 can be configured to have its mass distributed on circle hook body 12 to balance weight 30 in a desired and predetermined manner. Such a hook 10 can be useful when trolling in a body of water with hook 10 attached to bait, such as smaller fish-type bait, or other bait such as squid. Hook 10 can also be used with artificial bait. The configuration of weight 30 can be such that hook 10 can be disposed through at least a portion of the head, chin and/or mouth of a bait fish and hook 10 remains in an upright position where circle hook 10 is stabilized in position with bend 22 of hook body 12 being generally closer to a surface of the body of water than shank 20 is. The mass and configuration of weight 30 can be great enough to stabilize the position of circle hook 10 with bend 22 of circle hook body 12 being closer to the surface of the body of water than shank 20 when hook 10 is attached to bait. As used herein, the configuration of a weight refers to the size, shape, and placement of the weight on a hook body. The mass of weight 30 can also be balanced to create a swimming action in a live or dead bait fish with a tail of the bait fish oscillating from side to side upon trolling at an appropriate speed.

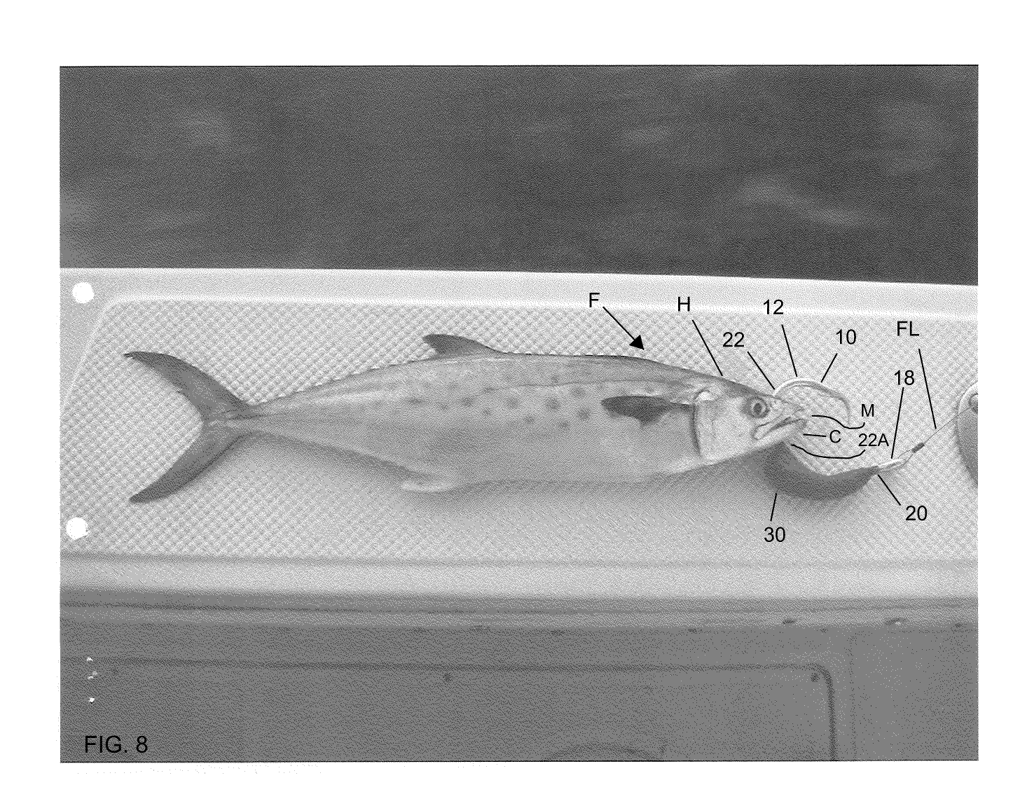

For example, as shown in FIG. 8, hook 10 can be disposed in a bait fish F through a head H of bait fish F. In particular, hook 10 can be inserted through a chin C and mouth M of head H of bait fish F. Upon insertion of hook 10, bait fish F can reside on bend 22 of hook body 12 of hook 10 with weight 30 under chin C of bait fish F. Weight 30, as stated above, can reside on a lower portion 22A of bend 22 and on at least a portion of shank 20. Fishing line FL which is secured to eye 18 can extend from eye 18 of hook 10 up to a rod and reel (not shown). Upon insertion of hook 10 into bait fish F, fishing line FL can pull hook 10 and bait fish F through the water. Weight 30 in its position on hook 10 can balance and stabilize hook 10 as it travels through the water as is explained in more detail below. The size and mass of weight 30 can be dependent upon the size and shape of the bait.

Weight 30 can be molded on hook 10. For example, weight 30 can be centrifugal cast molded onto hook 10. Alternatively, weight 30 can be separately molded or machined and then attached. For example, weight 30 can be removable attachable to hook body 12. Weight 30 can comprise metal. For example, weight 30 can comprise lead. Weight 30 can be aerodynamic (i.e., fluid dynamic) enough and can be correctly balanced to maintain hook 10 in an upright position with bend 22 and point 24 closer to a surface of a body of water when trolling than at least most of shank 20, even when the hook is baited. For example, point 24 of hook 10 resides above shank 20 when trolling. Weight 30 can be design in a such a shape that it acts like a keel to keep hook 10 properly aligned even with the turbulent forces of the water flow created by the trolling and the forces created by the swimming action of the bait fish.

As shown in FIG. 1, bend 22 of circle hook 10 can include, for example, at least two radii of curvatures R₁ and R₂, with a first radius of curvature R₁ extending from shank 20 and a second radius of curvature R₂ extending between first radius of curvature R₁ and point 24. Bend 22 of the hook body can include other radius of curvatures between first radius of curvature R₁ and second radius of curvature R₂. Weight 30 can extend from shank 20 around at least a portion of first radius of curvature R₁ of bend 22 of circle hook body 12. For example, weight 30 can extend partially up first radius of curvature R₁ of bend 22 with a portion of first radius of curvature R₁ of bend 22 being exposed (i.e., having no portion of weight 30 thereon) on an end nearest second radius of curvature R₂ of bend 22. In other embodiments, weight 30 can extend up first radius of curvature R₁ of bend 22 with no portion of first radius of curvature R₁ not encased by weight 30. Shank 20 and bend 22 of circle hook body 12 can define an inside area I of circle hook body 12 therein and a majority of the mass of weight 30 can reside on an outer perimeter O of hook 10 outside of inside area I of circle hook body 12.

As shown in FIG. 1, point 24 on the end of bend 22 can extend toward shank 20 on circle hook body 12 of hook 10. For example, point 24 can curve toward shank 20 at a constant radius of curvature R₃. Point 24 can include a barb 26 that extends into inside area I of circle hook body 12.

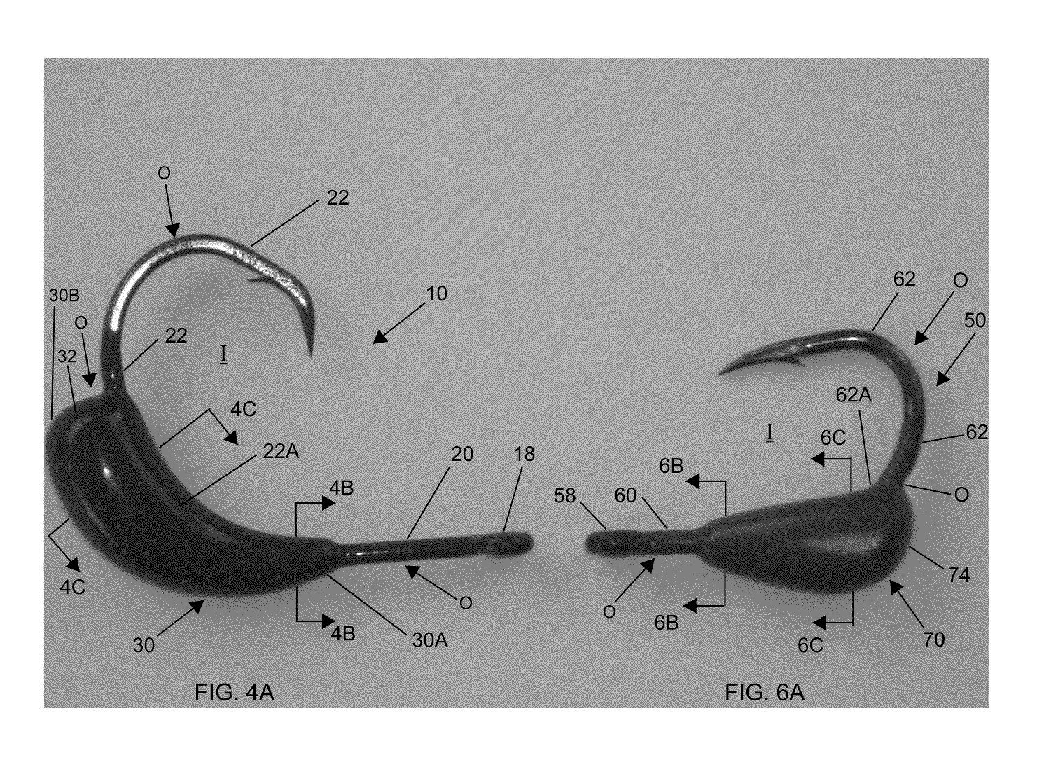

The portion of weight 30 on first radius of curvature R₁ of bend 22 can be greater in mass than the portion of weight 30 on shank 20. For example, as shown in FIG. 4A, a portion 30B of weight 30 on lower portion 22A of bend 22 can be greater in mass than a portion 30A of weight 30 on shank 20 of hook 10. A cross-sectional view of portion 30A of weight 30 on shank 20 of hook 10 taken along lines 4B-4B and a cross-sectional view of portion 30B of weight 30 on lower portion 22A of bend 22 taken along lines 4C-4C are shown in FIGS. 4B and 4C, respectively, to further illustrate the difference in size of weight 30 at the respective areas. As shown in FIG. 4B, portion 30A of weight 30 secured on and/or around shank 20 can have a cross-sectional area 30A₁. The majority of the mass at this portion 30A of weight 30 is on outer perimeter O of shank 20 of hook 10. As shown in FIG. 4C, portion 30B of weight 30 secured on and/or around lower portion 22A of bend 22 can have a cross-sectional area 30B₁. Also, at this point, the majority of the mass at portion 30B of weight 30 is on outer perimeter O of bend 22 of hook 10.

As can be seen from FIGS. 4B and 4C, cross-sectional area 30B₁ of weight 30 on lower portion 22A of bend 22 can be larger than cross-sectional area 30B₁ of weight 30 on shank 20. Weight 30 can taper from lower portion 22A of bend 22 to shank 20 as the cross-sectional areas gradually and/or smoothly decrease. Thereby, weight 30 can generally diverge outward from shank 20 to a specified location along lower portion 22A of bend 22. In some embodiments, after gradually diverging or increasing to a certain cross-sectional shape and size, the cross-sectional shape and size of weight 30 can remain about constant until it descends or tapers to an end. In other embodiments, the cross-sectional shapes and sizes may diverge outward to a specific location and then taper to or more abruptly terminate at an end. Alternatively, the change in cross-sectional shape and size of the weight can be stepped. As shown in FIGS. 1 and 4A, end 34 can protrude out from hook body 12 in outer perimeter O. It is noted that weight 30 can have different sizes and different cross-sectionals shapes.

The shape of weight 30 can help to align hook 10 when being pulled in a body of water with bend 22 of circle hook body 12 being closer to the surface of the body of water than shank 20 when hook 10 is attached to bait. For example, the outward divergence of weight 30 from a smaller cross-section at shank 20, which leads hook 10 in the water when hook 10 is being pulled during trolling, to the larger cross-section at lower portion 22A of bend 22 can help to stabilize hook 10 in the water. In particular, such a shape of weight 30 can aid in the alignment of hook 10 when in use so that bend 22 of circle hook body 12 is closer to the surface of the body of water than shank 20 when hook 10 is attached to bait. In other words, point 24 of hook 10 can reside above shank 20 when trolling. In such a manner, weight 30 can act like a keel to keep hook 50 properly aligned even with the turbulent forces of the water flow created by the trolling and the forces created by the swimming action of the bait fish.

Hook 10 can have weight 30 positioned along shank 20 and bend 22 such that weight 30 does not interfere with bite B of hook 10. Bite B of hook 10 comprises the area from point 24 on bend 22 of hook body 12 to the shanks as shown in FIG. 1. While weight 30 can extend over shank 20 into the inside area of hook 10 in some embodiments, the amount of overlap can be small enough to not effectively shorten bite B of hook 10. This means that the size of weighted hook 10 can be considered the same as an unweighted hook in terms of the type of fish for which they can be used.

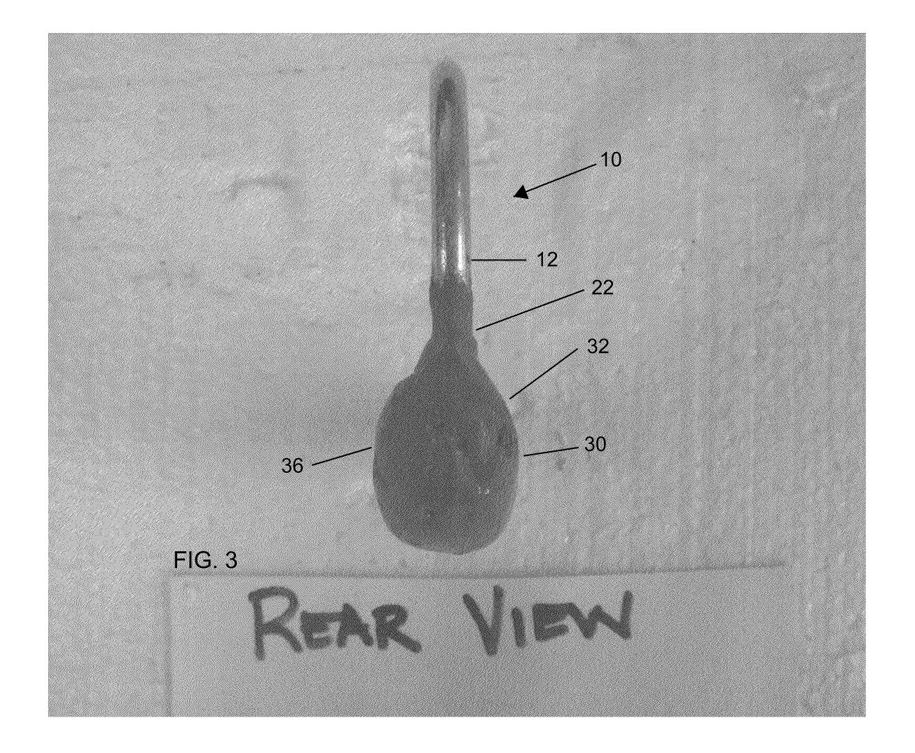

Weight 30 can also be distributed evenly on either side of hook 10. As shown in FIG. 3, weight 30 can have a side 36 on, for example, a left side of shank 20 and bend 22 of hook 10 and another side 32 on a right side of shank 20 and bend 22 portion of hook 10. Side 36 can be generally equal in size and weight to the other side 32 of weight 30 to balance hook 10 when trolling in a body of water. As an example, in such embodiments when hook 10 is oriented in an upright position, shank 20 and bend 22 can be positioned in weight 30 such that shank 20 and portion 22A of bend 22 of hook 10 are off centered within weight 30 in a longitudinal direction and centered in a latitudinal direction so that weight 30 is symmetrical about shank 20 and portion 22A of bend 22 of hook 10 along an axis A.

For example, as shown in FIGS. 4B and 4C, a coordinate system that is applicable at a position perpendicular to the orientation of the hook at any given point of the hook body is shown in relation to the cross-sections shown. In the coordinate system, the x-axis can represent the longitudinal direction and the y-axis can represent the latitudinal direction. As shown in FIGS. 4B and 4C, weight 30 does not have to be centered within the weight in the longitudinal direction in this embodiment at either cross-section. In particular, weight 30 can have most of its mass below shank 20 and portion 22A of bend 22. However, weight 30 can be centered in the latitudinal direction with side 36 being generally about equal in size and shape with the other side 32 so that weight 30 is about symmetrical about a longitudinal axis A.

Portion 32 of weight 30 on bend 22 can be greater in mass than portion 34 of weight 30 on the shank. In such an embodiment, at least weight 30 can, but does not have to, have a color that is different from circle hook body 12. For example, at least an outer portion of weight 30 can be red in color. Further, at least weight 30 comprises a color different from point 24. The color can be painted on weight 30 and/or circle hook body 12. Alternatively, the material used to create weight 30 can be colored. The color of weight 30, for example, can help attracted attention to baited hook 10. This can be especially true when using the color red, which often draws attention of predator fish and denotes injury or weakness in the bait.

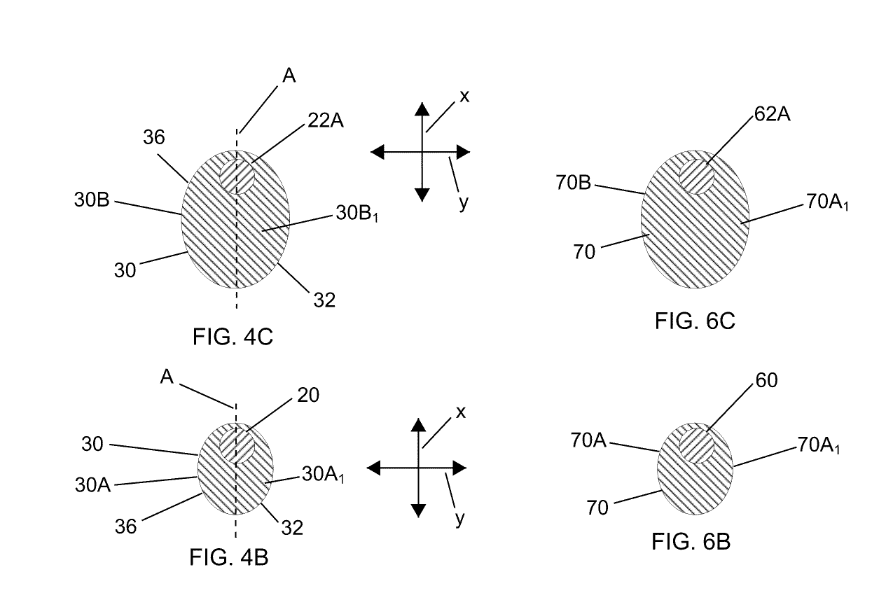

FIG. 5 shows another embodiment of a hook 50. Hook 50 is a J-hook. J-hook 50 can comprise a hook body 52. Hook body 52 can comprise a shank 60 and a bend 62 and a weight 70 that can be disposed on hook body 52. Weight 70 can reside on shank 60 and can extend over at least a lower portion 62A of bend 62 as shown. Further, weight 70 can be configured to have its mass distributed on hook body 52 to balance J-hook 50 such that when trolling with J-hook 50 in a body of water hook 50 is stabilized in a position with bend 62 of J-hook body 52 being closer to a surface of the body of water than shank 60 is. In other words, point 24 of hook 10 can reside above shank 20 when trolling or when the fishing line to which hook 70 is attached is being reeled at an appropriate speed.

The mass of weight 70 can be great enough to stabilize the position with bend 62 of J-hook body 52 is closer to the surface of the body of water than shank 60 when hook 50 is baited. The mass of weight 70 can be balanced to create a swimming action in alive or dead bait fish with a tail of the bait fish oscillating from side to side upon trolling at an appropriate speed.

As above, weight 70 can be molded on hook 50. For example, weight 70 can be centrifugal cast molded onto hook 50. Alternatively, weight 30 can be separately molded or machined and then attached. For example, weight 30 can be removable attachable to hook body 12. Weight 70 can comprise a metal. For example, weight 70 can comprise lead. Weight 70 can be aerodynamic enough and can be correctly balanced to maintain hook 50 in an upright position with bend 62 and point 64 closer to a surface of a body of water when trolling than at least most of shank 60, even when the hook is baited. For example, point 24 of hook 10 resides above shank 20 when trolling. Such an orientation with point 24 of hook 10 being in an upper position above shank 20 can also help to prevent snagging on material within the water like underbrush or weeds by keeping point 24 of hook 10 up in the water. Weight 70 can be design in a such a shape that it acts like a keel to keep hook 50 properly aligned even with the turbulent forces of the water flow created by the trolling and the forces created by the swimming action of the bait fish acting on hook 50.

Bend 22 can include at least two radii of curvatures R₄ and R₅, with a first radius of curvature R₄ extending from shank 60 and a second radius of curvature R₅ extending between first radius of curvature R₄ and a point 64 on a portion of bend 62 that extends about parallel to shank 60 at an end 54 of hook body 52. Weight 70 can extend from shank 60 around first radius of curvature R₄ of bend 62. Shank 60 and bend 60 can define an inside area I₂ of J-hook body 52 therein and a majority of the mass of weight 70 can reside on an outer perimeter O₂ of J-hook body 52. The portion of weight 70 on first radius of curvature R₄ of bend 62 can be greater in mass than the portion of weight 70 on shank 60.

Point 64 on a portion of bend 62 can have a slight curve so that point 64 points past an eye 58 on the shank at end 56 of hook body 52. Alternatively, point 64 can extend about parallel to shank 60. Point 64 can include a barb 66 that extends into inside area I₂ of hook body 52.

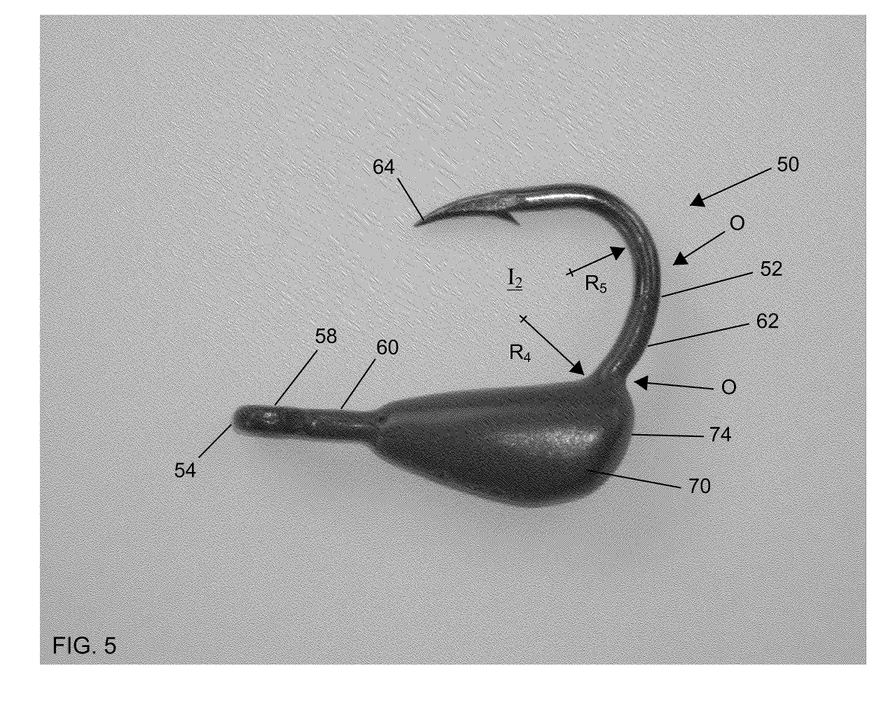

Portion of weight 70 on bend 62 can be greater in mass than the portion of weight 70 on shank 60. For example, as shown in FIG. 6A, portion 70B of weight 70 on lower portion 62A of bend 62 can be greater in mass than portion 70A of weight 70 on shank 60 of hook 50. A cross-sectional view of portion 70A of weight 70 on shank 60 of hook 50 taken along lines 6B-6B and a cross-sectional view of portion 70B of weight 70 on lower portion 62A of bend 62 taken along lines 6C-6C are shown in FIGS. 6B and 6C, respectively, to further illustrate the difference in size of weight 70 at the respective areas. As shown in FIG. 6B, portion 70A of weight 70 secured on and/or around shank 60 can have a cross-sectional area 70A₁. The majority of the mass at this portion 70A of weight 70 is on outer perimeter O₂ of shank 60 of hook 60. As shown in FIG. 6C, portion 70B of weight 70 secured on and/or around lower portion 62A of bend 62 can have a cross-sectional area 70B₁. Also, at this point, the majority of the mass at portion 70B of weight 70 is on outer perimeter O₂ of bend 62 of hook 50.

As can be seen from FIGS. 6B and 6C, cross-sectional area 70B₁ of weight 70 on lower portion 62A of bend 62 can be large than cross-sectional area 70B₁ of weight 70 on shank 60. Weight 70 can taper from lower portion 62A of bend 62 to shank 60 as the cross-sectional areas gradually and/or smoothly decrease. Thereby, weight 70 can generally diverge outward from shank 60 to a specified location along lower portion 62A of bend 62. In some embodiments, after gradually diverging or increasing to a certain cross-sectional shape and size, the cross-sectional shape and size of weight 70 can remain about constant until it descends or tapers to an end. In other embodiments, the cross-sectional shapes and sizes may diverge outward to a specific location and then taper to or more abruptly terminate at an end. Alternatively, the change in cross-sectional shape and size of weight can be stepped. As shown in FIGS. 5 and 6A, end 74 can protrude out from hook body 52 in outer perimeter O₂. It is noted that weight 70 can have different shapes and different cross-sectionals shapes. The shape of weight 70 can help to align hook 50 when being pulled in a body of water with bend 62 of J-hook body 52 being closer to the surface of the body of water than shank 60 when hook 50 is attached to bait. In other words, point 64 of hook 50 can reside above shank 60 when trolling.

As above, at least weight 70 can include a color. For example, at least an outer portion of weight 70 can be red in color. Further, at least weight 70 can have a color different from point 64.

In this manner, a J-hook 50 can be provided that includes a hook body 52 and a weight 70 disposed on hook body 52. Weight 70 can be configured to have its mass distributed on J-hook body 52 to balance hook 50 such that when trolling with hook 50 in a body of water hook 50 is stabilized in a position relative to a surface of the body of water. The mass of weight 70 can be great enough to stabilize the position of hook body 52 relative to the surface of the body of water when hook 50 is baited.

Hooks 10, 50 according the present subject matter can come in different sizes from smaller and medium sizes used to catch stripped bass, flounder, blue, mackerel, grouper, or the like, to larger sizes used to catch bill fish such as black, blue, and white marlin, and sailfish, as well as other large game fish such as tuna, or the like. For example, the weighted hooks can come in four different sizes.

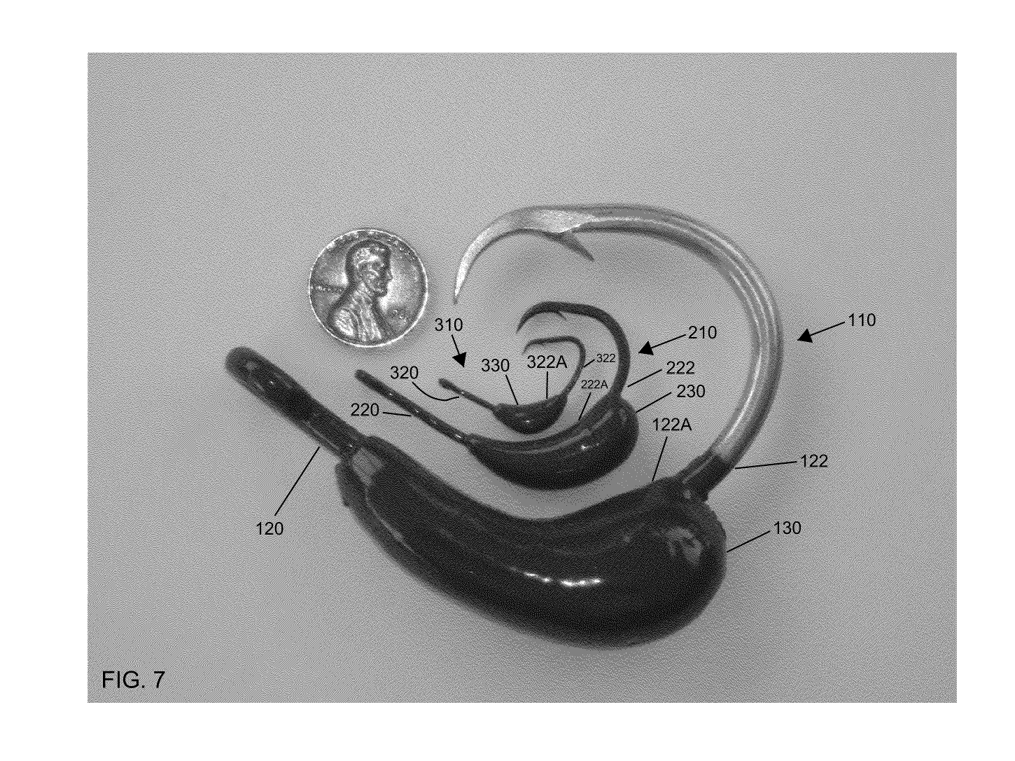

As shown in FIG. 7, three different sizes of circle hooks are provided. The weight disposed on each hook is appropriately sized for that hook. For example, the large hook has a larger weight as compared to the medium hook or the smaller hook. With each hook, the placement and configuration of a weight may be different so that its mass is distributed on each hook body to balance the hook such that when trolling with the hook in water the hook is stabilized in a position with a bend of the hook body being closer to a surface of the water than a shank of the hook to the surface of the water when baited. In each embodiment, though, the weight can reside on a portion of the shank and a lower portion of the bend of the hook.

For example, in a large hook 110, a weight 130 can be positioned on a portion of a shank 120 and a lower portion 122A of a bend 122 of hook 110 closest to shank 120. In a medium hook 210, a weight 230 can also be positioned on a portion of a shank 220 and a lower portion 222A of a bend 222 of hook 210 closest to shank 220. Weight 230 on hook 210 can be differently positioned as compared to weight 130 on hook 110. For example, weight 230 can be positioned more compactly relative to the respective hook 210 as compared to larger hook 110. Also, more of shank 220 of hook 210 can be exposed (i.e., not covered by weight 230) than on shank 120 of larger hook 110, relatively speaking. Further, relatively more of bend 222 can have weight 230 on hook 210 attached thereto as compared to larger hook 110. In a smaller hook 310, a weight 330 can also be positioned on a portion of a shank 320 and a lower portion 322A of a bend 322 of hook 310 closest to shank 320. However, weight 330 on hook 310 can be differently positioned as compared with either weight 130 on hook 110 or weight 230 on hook 210. For example, relatively more of shank 310 can be exposed as compared to shank 120 of larger hook 110, while less of bend 322 can have weight 330 attached thereto as compared to bend 222 of medium hook 210, respectively.

Thus, the size, placement, and configuration of a weight on a portion of a shank and a lower portion of a bend of a hook closest to the shank can vary based on the size, shape and configuration of the respective hook. The placement of such weight can vary even on a specific size and shape of hook as long as, when trolling with the hook in water, the hook can be stabilized in a position with a bend of the hook body being closer to a surface of the water than a shank of the hook is to the surface of the water when baited.

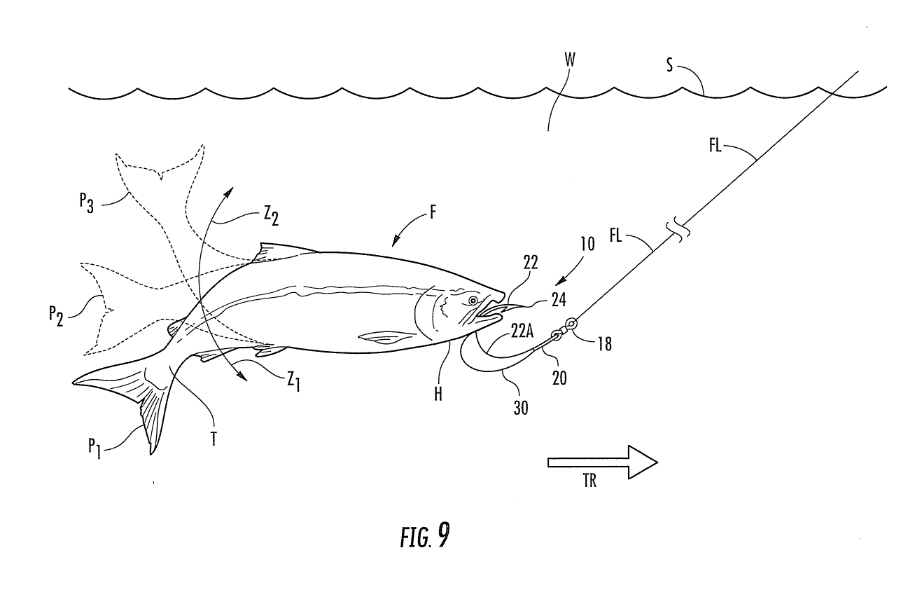

As shown in FIGS. 8 and 9, the weighted hooks of the present subject matter can be easily baited with live or dead fish and still achieve the desired swimming action of the oscillating tail of a bait fish or the swimming movement of a squid, for example. This is at least partially due to the position and design of the weight on the hook. The weighted hooks of the present subject matter can be easily rigged or baited. For example, when using bait fish such as Spanish mackerel, bluefish or split tail mullet, a fresh or frozen Spanish mackerel, blue or mullet can be limbered up by working the tail back and forth. A live bait fish may not require this limbering. The bait fish can be hooked through the head, for example, through the chin, mouth and nose as shown in the FIG. 8. In particular, hook 10 can be disposed in a bait fish F through a head H of bait fish F. For example, hook 10 can be inserted through a chin C and mouth M of head H of bait fish F. Upon insertion of hook 10, bait fish F can reside on a bend 22 of a hook body 12 of hook 10 with a weight 30 under chin C of bait fish F. Weight 30, as stated above, can reside on a lower portion 22A of bend 22 closest to a shank 20 and on at least a portion of shank 20. A skirt (not shown) can be optional provided or used with bait fish F. Bait hook 10 can then be deployed into the water for fishing.

When using bait fish such as squid, for example, the squid can be hooked through the head. A skirt (not shown) can be optional provided or used, if desired. The baited hook can then be deployed into the water for fishing.

Once in the water, the hook can be stabilized in a position with the point of the hook above the shank closer to a surface of the water when baited. As shown in FIG. 9, hook 10 is deployed in a body of water W. As shown in FIG. 9, bait fish F is hooked through a head H of bait fish F. In particular, the hook 10 is inserted through a chin C and mouth M of head H of bait fish F such that bait fish F resides on bend 22 of hook body 12 of hook 10 with weight 30 under chin C of bait fish F. It is understood that hook 10 can be inserted into fish F at different places through fish F and in different manners. In the embodiment of hook 10 shown, weight 30 resides on at least a portion of shank 20 and on a lower portion 22A of bend 22. For example, lower portion 22A can be a portion of the bend 22 closest to shank 20.

Once in water W, a fishing line FL which can be secured to eye 18 and can extend from the eye 18 of the hook 10 up to a rod and reel (not shown) can pull hook 10 and bait fish F through water W. The depth within water W at which trolling occurs can vary. As shown in FIG. 9, weight 30 in its position on hook 10 can balance and stabilize hook 10 as it travels through water W. Hook 10 can generally remain in an upright position where bend 22 of hook body 12 is closer to a surface S of the body of water W than shank 20 is to surface S of water W. In other words, point 24 of hook 10 can reside above shank 20 when trolling. The mass of weight 30 in combination with the configuration of weight 30 can be used to stabilize the position of hook 10 with bend 22 and point 24 of hook body 12 being closer to surface S of water W than shank 20 when hook 10 is attached to bait as shown in FIG. 9. Such an orientation with point 24 of hook 10 being in an upper position above shank 20 can also help to prevent snagging on material within the water such as underbrush or weeds by keeping point 24 of hook 10 up in water W.

As shown in FIG. 9, hook 10 pulls bait fish F in a trolling direction TR with hook 10 leading bait fish F. As bait fish F is being pulled at an appropriate speed, hook 10 can generally reside in the position illustrated with bend 22 of hook body 12 being closer to surface S of water W than shank 20 is, thereby holding head H of fish F steady. Also as bait fish F is being pulled at an appropriate speed, tail T of fish F can oscillate in directions Z₁ and Z₂ between tail position P₁ in which tail T is currently shown residing and tail position P₂ (shown in dotted lines). For example, tail T can move from position P₁ to position P₃ (shown in dotted lines) and from position P₃ to position P₂. Then, tail T can move from position P₂ to position P₃ and from position P₃ to position P₁. This oscillation can create the appearance of fish F swimming in water W by creating a swimming action with tail T. This oscillation can be created by weight 30 holding hook 10 and head H of fish F as shown. The mass of weight 30 can also be balanced to facilitate the holding of hook 10 and fish F and oscillation of tail T. In this manner, weight 30 can create a swimming action in a live or dead bait fish with a tail of the bait fish oscillating from side to side upon trolling at an appropriate speed.

Embodiments of the present disclosure shown in the Figures and described above are exemplary of numerous embodiments that can be made within the scope of the present subject matter. It is contemplated that the configurations of the weighted hooks can comprise numerous configurations other than those specifically disclosed. Thus, the scope of the present subject matter in this disclosure should be interpreted broadly.

What is claimed is:

1. A hook comprising:
a hook body having a first end and a second end, the hook body comprising:
(i) an eye on the first end of the hook body having an aperture therein;
(ii) a shank extending linearly from the eye;
(iii) a bend curving from the shank;
(iv) a point on a portion of the bend, the point being on the second end of the hook body; and
a weight disposed on the hook body, the weight residing on at least a portion of the shank and extending over at least a portion of the bend closest to the shank.

2. The hook according to claim 1, wherein the portion of the weight on the bend is greater in mass than the portion of the weight on the shank.

3. The hook according to claim 1, wherein the bend comprises at least two radii of curvatures, with a first radius of curvature extending from the shank and a second radius of curvature extending between the first radius of curvature and the point.

4. The hook according to claim 3, wherein the weight extends from the shank around at least a portion of the first radius of curvature of the bend.

5. The hook according to claim 4, wherein the portion of the weight on the first radius of curvature of the bend is greater in mass than the portion of the weight on the shank.

6. The hook according to claim 1, wherein the shank and the bend define an inside area of the hook body therein and a majority of the mass of the weight resides on an outer perimeter of the hook body outside of the inside area of the hook body.

7. The hook according to claim 1, wherein the weight is configured to have its mass distributed on the hook body to balance the weight such that when trolling with the hook in water the hook is stabilized in a position with the bend of the hook body being closer to a surface of the water than the shank being to the surface of the water.

8. The hook according to claim 7, wherein the mass of the weight is balanced to create a swimming action in a bait fish with a tail of the bait fish oscillating from side to side upon trolling at an appropriate speed.

9. The hook according to claim 1, wherein the hook comprises a circle hook.

10. The hook according to claim 1, wherein the hook comprises a J-hook.

11. A circle hook comprising:
a circle hook body having a first end and a second end, the circle hook body comprising:
(i) an eye on the first end of the circle hook body having an aperture therein;
(ii) a shank extending linearly from the eye;
(iii) a bend curving outward from the shank and curving back toward the shank;
(iv) a point on a portion of the bend that curves back toward the shank, the point being on the second end of the circle hook body; and
a weight disposed on the circle hook body, the weight residing on the shank and extending over at least a portion of the bend closest to the shank.

12. The circle hook according to claim 11, wherein the portion of the weight on the bend is greater in mass than the portion of the weight on the shank.

13. The circle hook according to claim 11, wherein the bend comprises at least two radii of curvatures, with a first radius of curvature extending from the shank and a second radius of curvature extending between the first radius of curvature and the point.

14. The circle hook according to claim 13, wherein the weight extends from the shank around at least a portion of the first radius of curvature of the bend.

15. The circle hook according to claim 11, wherein the shank and the bend define an inside area of the hook body therein and a majority of the mass of the weight resides on an outer perimeter of the hook body outside of the inside area of the hook body.

16. A hook comprising:
a hook body comprising a shank and a bend; and
a weight disposed on the hook body, the weight residing on the shank and extending over at least a portion of the bend; and
the weight being configured to have its mass distributed on the hook body to balance the hook such that when trolling with the hook in water the hook is stabilized in a position with the bend of the hook body being closer to a surface of the water than the shank being to the surface of the water.

17. The hook according to claim 16, wherein the portion of the weight on the bend is greater in mass than the portion of the weight on the shank.

18. The hook according to claim 16, wherein the bend comprises at least two radii of curvatures, with a first radius of curvature extending from the shank and a second radius of curvature extending between the first radius of curvature and a point on a portion of the bend that curves back toward the shank at an end of the hook body.

19. The hook according to claim 18, wherein the weight extends from the shank around at least a portion of the first radius of curvature of the bend and the portion of the weight on the first radius of curvature of the bend is greater in mass than the portion of the weight on the shank.

20. The hook according to claim 16, wherein the shank and the bend define an inside area of the hook body therein and a majority of the mass of the weight resides on an outer perimeter of the hook body.
